(19) United States
(12) Patent Application Publication
(10) Pub. No.: US 2020/0184279 A1
(43) Pub. Date: Jun. 11, 2020

(54) INFORMATION PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Yusuke YAMAURA, Kanagawa (JP); Yukihiro TSUBOSHITA, Kanagawa (JP)

(73) Assignee: FUJI XEROX CO., LTD., Tokyo (JP)

(21) Appl. No.: 16/383,675

(22) Filed: Apr. 15, 2019

(30) Foreign Application Priority Data
Dec. 5, 2018 (JP) 2018-228519

(51) Int. Cl. G06K 9/62; G06K 9/00; G06K 9/46; G06N 3/08

(52) U.S. Cl. CPC G06K 9/6267; G06K 9/00255; G06K 9/00261; G06N 3/08; G06K 9/4604; G06K 9/00288; G06K 9/6256

(57) ABSTRACT

An information processing apparatus includes an acquisition unit that acquires first impression information representing a first impression and second impression information representing a second impression for each of plural images including an image in which a subject is imaged and plural partial images including a part of the subject, the first impression being an impression received by a person, and the second impression being an impression received by the person and different from the first impression, a setting unit that sets a weight corresponding to the corresponding second impression information for the first impression information related to each of the plural images based on each of the plural images and the second impression information, and an output unit that outputs the first impression of the image in which the subject is imaged from the first impression information related to each of the plural images using the weight set by the setting unit.

### CROSS-REFERENCE TO RELATED APPLICATIONS

This application is based on and claims priority under 35 USC 119 from Japanese Patent Application No. 2018-228519 filed Dec. 5, 2018.

### BACKGROUND

### (i) Technical Field

The present invention relates to an information processing apparatus and a non-transitory computer readable medium storing a program.

### (ii) Related Art

JP6023058B discloses an image processing apparatus including a split unit that splits each of a plurality of images into a plurality of segments, a calculation unit that calculates a priority of each segment in one image based on a relationship between different segments in the one image or a relationship between the segment of the one image and the segment of another predetermined image, and a classification unit that classifies the split segment into any one type of an object, a foreground, and a background. The calculation unit performs the calculation using at least one of a focus degree of the segment, a concurrency degree of the segment, or an object priority. The calculation unit calculates the focus degree of the segment to be increased as the segment approaches a focus position at which an imaging person is estimated to focus, and calculates the priorities of a foreground segment and a background segment based on the calculated focus degree of the segment. The calculation unit obtains the centroid of an object segment in the one image and obtains a position in point symmetry with the centroid about the center point of the image as a center.

JP2015-204030A discloses a recognition apparatus including a candidate area extraction section that extracts a candidate area of a subject from an image, a feature extraction section that extracts a feature related to an attribute of the image from the candidate area of the subject extracted by the candidate area extraction section, an attribute determination section that determines an attribute of the candidate area of the subject extracted by the candidate area extraction section based on the feature extracted by the feature extraction section, and a determination result integration section that identifies the attribute of the image by integrating the determination result of the attribute determination section.

JP2017-004480A discloses a saliency information acquisition apparatus including a local saliency acquisition unit that calculates a saliency degree of a pixel or the like of an input image based on information acquired from a local area around each pixel, a candidate area setting unit that sets a plurality of candidate areas for the input image, a global saliency acquisition unit that calculates the saliency of each of the plurality of candidate areas based on information including a local saliency feature representing a feature of the saliency for each pixel in each candidate area and a global feature representing a feature of each candidate area with respect to the whole input image, and an integration unit that generates saliency information related to the input image by integrating the saliency degrees of the plurality of candidate areas acquired by the global saliency acquisition unit.

JP5330530B discloses an image management apparatus including an image acquisition section that acquires an image group, an object detection section that detects an object included in an image for each image acquired by the image acquisition section, an object classification section that classifies each object detected in each image acquired by the image acquisition section into any of a plurality of clusters depending on an object feature of each object, an object priority evaluation section that evaluates an object priority that is the priority of the object using an evaluation value calculated based on a likelihood indicating the level of correlation between the object and the cluster and a magnitude of the number of objects belonging to the same cluster as the object, and an image priority evaluation section that evaluates the priority of one image based on the object priority of the object included in the one image. The object priority evaluation section calculates the likelihood based on concurrency information and a similarity. The concurrency information is information related to concurrency between the clusters and includes a concurrency degree based on the number of times a concurrency relationship is detected in the image group. The similarity indicates a degree to which the values of the object feature of the object and a cluster feature of the cluster are close to each other.

### SUMMARY

In the case of obtaining an impression of an image acquired by imaging a subject, the impression of the captured image may be obtained by considering an impression of a partial image acquired by extracting a part of the subject.

Aspects of non-limiting embodiments of the present disclosure relate to an information processing apparatus and a non-transitory computer readable medium storing a program that can obtain an impression of a captured image more accurately than in a case of deciding a weight of an impression received by a person from a partial image using only one partial image acquired by extracting a certain part from an image acquired by imaging a subject, and obtaining the impression of the captured image from the weight.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including an acquisition unit that acquires first impression information representing a first impression and second impression information representing a second impression for each of a plurality of images including an image in which a subject is imaged and a plurality of partial images including a part of the subject, the first impression being an impression received by a person, and the second impression being an impression received by the person and different from the first impression, a setting unit that sets a weight corresponding to the corresponding second impression information for the first impression information related to each of the plurality of images based on each of the plurality of images and the second impression information, and an output unit that outputs the first impression of the image in which the subject is imaged from the first impression information related to each of the plurality of images using the weight set by the setting unit.

### BRIEF DESCRIPTION OF THE DRAWINGS

Exemplary embodiment(s) of the present invention will be described in detail based on the following figures, wherein:

FIG. 1 is a block diagram illustrating one example of an electric configuration of an information processing apparatus according to an exemplary embodiment of the present invention;

FIG. 2 is a block diagram illustrating one example of a functional configuration of the information processing apparatus according to the exemplary embodiment of the present invention;

FIG. 3 is a graph illustrating one example of an impression classification result;

FIG. 4 is a schematic diagram describing a procedure of extracting a partial area from an interior image;

FIG. 5 is a schematic diagram specifically describing a procedure of an integration process;

FIG. 6 is a schematic diagram illustrating one example of a taste (first impression) and a room (second impression) of the whole image and each partial image;

FIG. 7 is a schematic diagram illustrating one example of training data according to the exemplary embodiment of the present invention;

FIG. 8 is a block diagram illustrating one example of a configuration of a learning function of the information processing apparatus according to the exemplary embodiment of the present invention;

FIG. 9 is a block diagram illustrating another example of input and output of an impression classification unit;

FIG. 10 is a block diagram illustrating another example of the configuration of the learning function of the information processing apparatus according to the exemplary embodiment of the present invention;

FIG. 11 is a block diagram illustrating still another example of the input and output of the impression classification unit;

FIG. 12 is a flowchart illustrating one example of a flow of “impression output process” according to the exemplary embodiment of the present invention;

FIG. 13 is a flowchart illustrating one example of a flow of “impression classification process”;

FIG. 14 is a flowchart illustrating one example of a flow of “weight setting process”;

FIG. 15 is a flowchart illustrating one example of a flow of “integration process”;

FIG. 16 is a schematic diagram describing a procedure of extracting the partial area from a face image;

FIG. 17 is a schematic diagram specifically describing the procedure of the integration process; and

FIG. 18 is a schematic diagram illustrating one example of an age (first impression) and a sex (second impression) of the whole image and each partial image.

### DETAILED DESCRIPTION

Hereinafter, one example of an exemplary embodiment of the present invention will be described in detail with reference to the drawings.

Information Processing Apparatus

An information processing apparatus according to the exemplary embodiment of the present invention will be described.

Electric Configuration

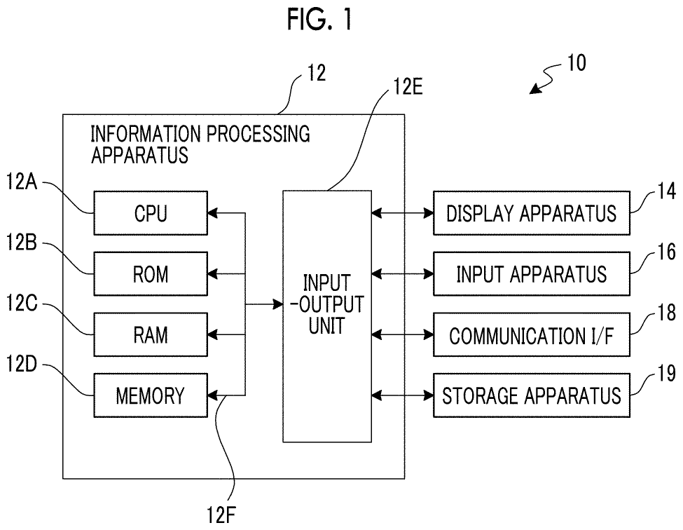

First, an electric configuration of the information processing apparatus will be described. FIG. 1 is a block diagram illustrating one example of the electric configuration of the information processing apparatus according to the exemplary embodiment of the present invention. An information processing apparatus 12 is configured as a computer that controls each connected apparatus and performs various calculations. That is, the information processing apparatus 12 includes a central processing unit (CPU) 12A, a read only memory (ROM) 12B, a random access memory (RAM) 12C, a non-volatile memory 12D, and an input-output unit (I/O) 12E.

The CPU 12A, the ROM 12B, the RAM 12C, the memory 12D, and the I/O 12E are connected to each other through a bus 12F. For example, the CPU 12A reads a program stored in the ROM 12B and executes the program using the RAM 12C as a work area. In addition, for example, a display apparatus 14 such as a display, an input apparatus 16 such as a keyboard or a mouse, a communication interface (I/F) 18, and a storage apparatus 19 may be connected to the I/O 12E of the information processing apparatus 12 as peripheral apparatuses.

The communication I/F 18 is an interface for communicating with an external apparatus through a wired or wireless communication line. For example, the communication I/F 18 functions as an interface for communicating with the external apparatus such as a computer connected to a network such as a local area network (LAN) or the Internet. The storage apparatus 19 is an external storage apparatus such as a hard disk.

Various programs and various data are stored in a storage apparatus such as the ROM 12B. In the present exemplary embodiment, a program for executing an “impression output process” described below is stored in the ROM 12B. A storage area of the program is not limited to the ROM 12B. Various programs may be stored in other storage apparatuses such as the memory 12D and the storage apparatus 19 or may be acquired from the external apparatus through the communication I/F 18.

In addition, various drives may be connected to the information processing apparatus 12. Various drives are apparatuses that read data from a computer readable portable recording medium such as a CD-ROM or a Universal Serial Bus (USB) memory or write data into the recording medium. In the case of including various drives, the program may be recorded on a portable recording medium and may be read and executed by a corresponding drive.

Functional Configuration

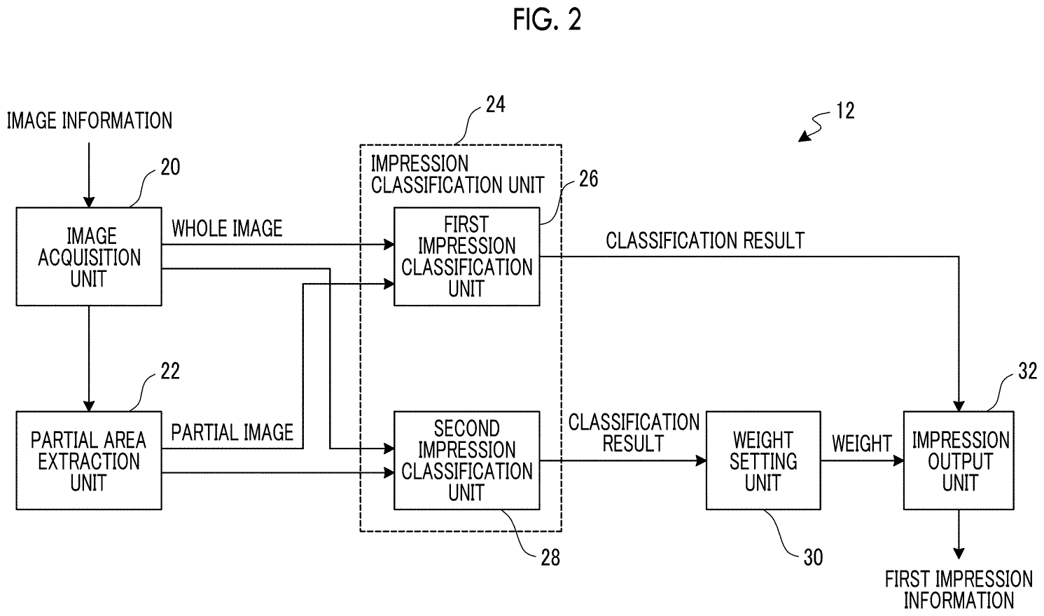

Next, a functional configuration of the information processing apparatus 12 will be described. FIG. 2 is a block diagram illustrating one example of a functional configuration of the information processing apparatus according to the exemplary embodiment of the present invention. As illustrated in FIG. 2, the information processing apparatus 12 includes an image acquisition unit 20, a partial area extraction unit 22, an impression classification unit 24, a weight setting unit 30, and an impression output unit 32. The impression classification unit 24 includes a first impression classification unit 26 and a second impression classification unit 28.

The image acquisition unit 20 acquires image information related to an image (hereinafter, referred to as the “whole image”) acquired by imaging a subject. The image acquisition unit 20 outputs the image information related to the acquired whole image to each of the first impression classification unit 26 and the second impression classification unit 28.

The partial area extraction unit 22 extracts a partial area having a part of the subject from the whole image acquired by the image acquisition unit 20. For example, in a case where the subject includes a plurality of objects, a candidate area (for example, a rectangular area) having high object likeness is cut using a sliding window or the like for each object. The partial area extraction unit 22 outputs the image information related to an image (hereinafter, referred to as a “partial image”) of the extracted partial area to each of the first impression classification unit 26 and the second impression classification unit 28.

The first impression classification unit 26 is a learned classification model. In a case where the image information is input, the first impression classification unit 26 executes a task of classifying a “first impression” received by a person from an image (hereinafter, referred to as an “input image”) related to the input image information. The first impression classification unit 26 outputs a classification result of the first impression (hereinafter, referred to as a “first impression classification result”) to the impression output unit 32. The first impression classification unit 26 outputs the first impression classification result of the whole image and the first impression classification result of each of a plurality of partial images to the impression output unit 32. The first impression classification result is one example of “first impression information”.

The impression received by the person from the image is an impression perceived by a viewer when seeing the image. The type of impression (what is perceived) received from the image changes depending on the subject, like “taste and room” in a case where the subject is an interior and “age and sex” in a case where the subject is a face. In addition, the classification of the impression (how is the impression) changes depending on the content of the subject such as color and shape. In the present exemplary embodiment, the subject includes a plurality of objects (or components), and the classification of the impression may change depending on the combination of the plurality of objects.

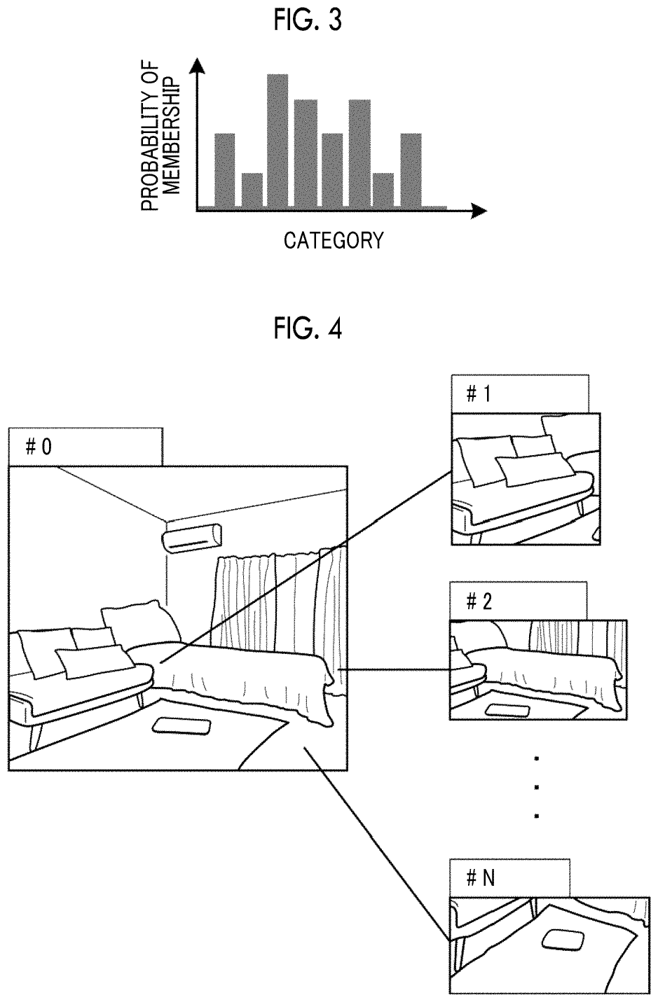

FIG. 3 is a graph illustrating one example of an impression classification result. As illustrated in FIG. 3, a plurality of different categories (hereinafter, referred to as a “plurality of categories as classifications”) set in advance depending on the subject are prepared as the classification of the impression. The impression classification result is information representing a classification score (probability distribution) that is the probability of membership to each of the plurality of categories as classifications. One category having a higher probability of membership than the other categories is estimated to be the “impression” received by the person from the input image.

For example, it is assumed that the subject is the interior, and the first impression is a “taste”. The plurality of categories as classifications such as modern, natural, and simple are prepared as a classification of taste. For example, in a case where there are only the three illustrated types of categories, the first impression classification result such as modern (0.5), natural (0.3), and simple (0.2) is output in a case where the image information is input. The number in parentheses is the probability of membership to the corresponding category. The category “modern” having a higher probability of membership than the other categories is estimated to be the first impression.

The second impression classification unit 28 is a learned classification model in the same manner as the first impression classification unit 26. In a case where the image information is input, the second impression classification unit 28 executes a task of classifying a “second impression” given to the person by the input image. The second impression classification unit 28 outputs a classification result of the second impression (hereinafter, referred to as a “second impression classification result”) to the weight setting unit 30. The second impression classification unit 28 outputs the second impression classification result of the whole image and the second impression classification result of each of the plurality of partial images to the weight setting unit 30. The second impression classification result is one example of “second impression information”.

For example, it is assumed that the subject is the interior, and the second impression is a “room (likeness)”. The plurality of categories as classifications such as a living room (R), a bed R, and a dining R are prepared as the classification of the room. For example, in a case where there are only the three illustrated types of categories, the second impression classification result such as the living R (0.5), the bed R (0.3), and the dining R (0.2) is output. The category “living R” having a higher probability of membership than the other categories is estimated to be the second impression.

The first impression and the second impression are two types of impressions acquired from the same image. The first impression classification unit 26 and the second impression classification unit 28 are multi-tasks of extracting and classifying a common feature from the same image and have correlation between each other. Thus, the classification result of one of the first impression classification unit 26 and the second impression classification unit 28 affects the classification result of the other of the first impression classification unit 26 and the second impression classification unit 28. In the present exemplary embodiment, the first impression classification result and the second impression classification result acquired from the same image are associated with each other.

The weight setting unit 30 sets a “weight” corresponding to the corresponding second impression classification result for each of the plurality of first impression classification results acquired from the first impression classification unit 26 based on the plurality of second impression classification results acquired from the second impression classification unit 28. For example, the “weight” of each of the plurality of first impression classification results is set based on a similarity between the plurality of second impression classification results.

The impression output unit 32 integrates the plurality of first impression classification results using the weights set by the weight setting unit 30. For example, the integrated first impression classification result is the sum of the weights of the plurality of first impression classification results and is information representing a corrected classification score. The impression output unit 32 outputs the “first impression after correction” of the whole image obtained from the integrated first impression classification result. The plurality of first impression classification results may be integrated using a part of the weights set by the weight setting unit 30. In addition, a part of the plurality of first impression classification results may be integrated.

In the present exemplary embodiment, the first impression classification result of the whole image and the first impression classification result of each of the plurality of partial images are weighted and integrated. Accordingly, the first impression originating from each of the plurality of objects is considered and reflected on the “first impression after correction” of the whole image. The first impression of the whole image based on the combination of the plurality of objects is more accurately obtained than that in a case where the first impression is estimated from only the whole image.

The “first impression after correction” of the whole image is a target output. In the present exemplary embodiment, in order to set the weight of each of the plurality of first impression classification results, the second impression classification result is acquired by executing a sub-task of classifying the “second impression” for the same image. By setting the weight corresponding to the corresponding second impression classification result for each of the first impression classification results, preliminary knowledge is not required, and the weight is dynamically changed.

In addition, in the present exemplary embodiment, the weight for the first impression classification result of the partial image is set based on the plurality of second impression classification results acquired from a plurality of images. That is, the weight for the first impression classification result of the partial image is set from a plurality of images such as the whole image and the partial image, and the partial image and other partial images. The classification accuracy for the first impression of the whole image is improved further than that in a case where the weight for the first impression classification result of the partial image is set from one partial image such that the probability of membership to the first impression (category) estimated from the first impression classification result is set as the weight.

The classification of the object (or the component) included in the subject, for example, the specification of a sofa, a bed, and the like in the case of the interior, may be performed by any of the first impression classification unit 26 and the second impression classification unit 28.

Weight Corresponding to Similarity

The “weight” corresponding to the “similarity” between the corresponding second impression classification result and other second impression classification results may be set for each of the plurality of first impression classification results. For example, the “weight” that is increased as the “similarity” is increased is set for each of the plurality of first impression classification results. The first impression changes depending on a situation in which the object is placed. By setting the weight based on the similarity between the second impression classification results, the weight is dynamically set depending on the situation in which the object is placed.

The similarity between the second impression classification results may be a similarity in a case where the second impression classification result of the corresponding partial image and the second impression classification result of the whole image are compared with each other. In a case where the second impression classification result of the partial image and the second impression classification result of the whole image are similar to each other, the weight of the corresponding first impression classification result is increased. In a case where the second impression classification result of the partial image and the second impression classification result of the whole image are different from each other, the weight of the corresponding first impression classification result is decreased.

In addition, the similarity between the second impression classification results may be a similarity in a case where the second impression classification result of the corresponding partial image and the second impression classification results of other partial images are compared with each other. In a case where the second impression classification results of the partial images are similar to each other, the weight of the corresponding first impression classification result is increased. In a case where the second impression classification result of the corresponding partial image is different from the second impression classification results of other partial images and is “left out”, the weight of the corresponding first impression classification result is decreased. Even in a case where the second impression classification result that is “left out” is similar to the second impression classification result of the whole image, the weight of the corresponding first impression classification result is decreased.

The weight of the first impression classification result of the whole image may be a value set in advance.

Similarity Between Classification Scores

The similarity between the second impression classification results is the similarity between the “classification scores” represented by the second impression classification results. In a case where the number of categories is M, the second impression classification result is represented by an M-dimensional feature vector having the classification score (the probability of membership to each of the M categories) as a feature. The second impression classification result is a point in an M-dimensional feature space. Accordingly, the “similarity” between two second impression classification results is represented by the distance between two points in the feature space. As the distance is decreased, the “similarity” is increased.

Similarity Between Second Impressions

In addition, in the present exemplary embodiment, the first impression classification result is one example of the “first impression information”, and the second impression classification result is one example of the “second impression information”. The first impression classification unit 26 may output one category of the first impression as the “first impression information”, and the second impression classification unit 28 may output one category of the second impression as the “second impression information”.

In this case, the similarity between the categories representing the “second impression” may be used instead of the similarity between the second impression classification results. For example, one category of the second impression is acquired from the second impression classification result. In this case, the “similarity” is obtained by comparing the categories with each other. For example, using majority rule for the plurality of acquired categories, the similarity may be set to be increased as the similarity belongs to a majority, and the similarity may be set to be decreased as the similarity belongs to a minority.

Alternatively, the similarity between the categories may be set in advance and stored as a table or a graph for the plurality of categories representing the “second impression”. For example, in a case where the second impression is the “room”, a high similarity is set between the living R and the dining R, and a low similarity is set between the dining R and the bed R.

### Specific Example

A specific example of estimating the “taste” of the interior image will be described. In this example, the taste acquired from the interior image is set as the “first impression”, and the room acquired from the interior image is set as the “second impression”.

FIG. 4 is a schematic diagram describing a procedure of extracting the partial area from the interior image. A plurality of objects such as a sofa, a bed, a table, a curtain, and a rug are captured in the interior image. The partial image is acquired for each object by detecting each of the plurality of objects. In the illustrated example, N partial images #1 to # N are acquired from a whole image #0.

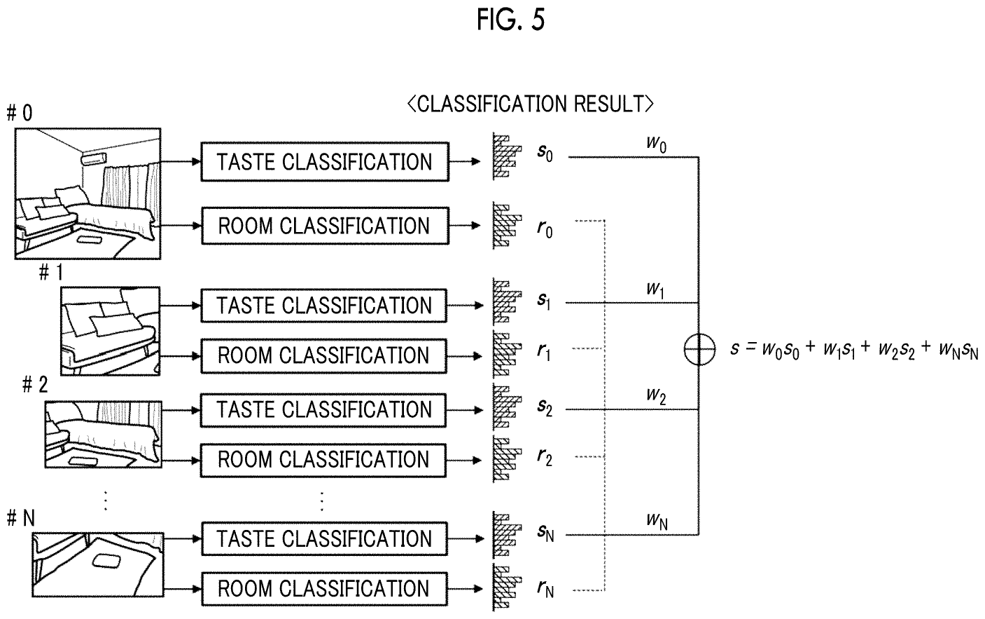

FIG. 5 is a schematic diagram specifically describing a procedure of an integration process. As illustrated in FIG. 5, taste classification and room classification are performed for the whole image #0 and the partial images #1 to # N using the learned classification model.

A taste classification result s₀ and a room classification result r₀ are acquired from the whole image #0. N taste classification results s₁ to s_{N} and N room classification results r₁ to r_{N} are acquired from the N partial images #1 to # N. A taste classification result sᵢ and a room classification result rᵢ are acquired from an i-th partial image # i of the partial images #1 to # N. Each of the taste classification results and the room classification results is information representing the classification score that is the probability of membership to each of the plurality of categories as classifications.

Corresponding weights w₀ to w_{N} are set for the taste classification results s₀ to s_{N}, respectively, by comparing the room classification results r₀ to r_{N} with each other. For example, the weights w₀ to w_{N} that are increased as the similarity is increased are set for the taste classification results s₀ to s_{N}, respectively, depending on the similarity between the room classification result rᵢ acquired from its image and a room classification result r (# rᵢ) acquired from another image.

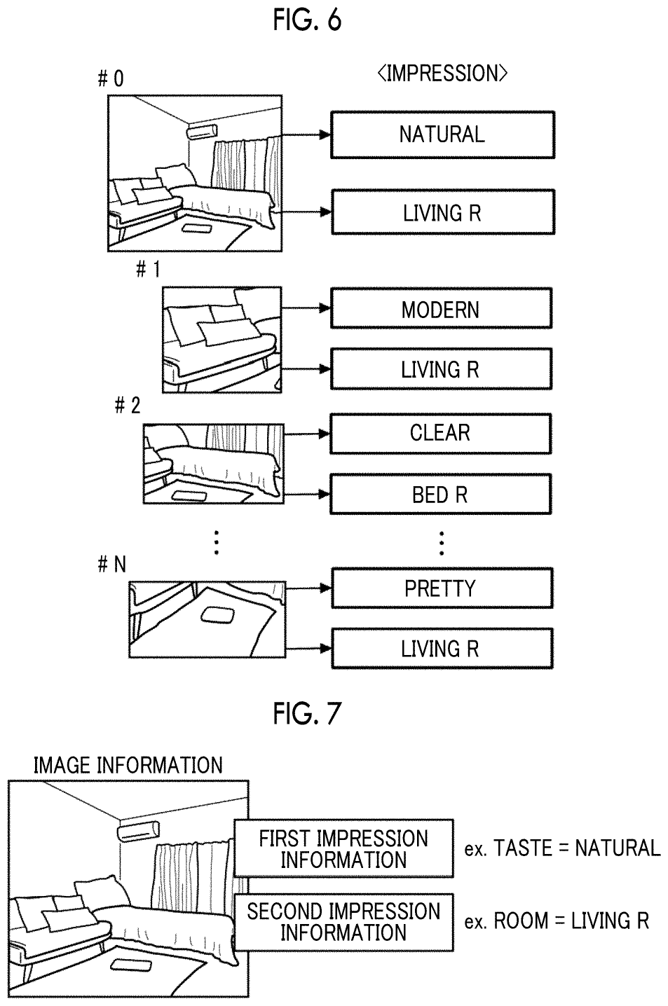

FIG. 6 is a schematic diagram illustrating one example of the taste (first impression) and the room (second impression) of the whole image and each partial image. In the illustrated example, with N=3, the partial image #1 of the sofa, the partial image #2 of the bed, and the partial image #3 of the rug are acquired from the whole image #0.

For the whole image #0, the taste is classified as “natural”, and the room is classified as the “living R”. For the partial image #1 of the sofa, the taste is classified as “modern”, and the room is classified as the “living R”. For the partial image #2 of the bed, the taste is classified as “clear”, and the room is classified as the “bed R”. For the partial image #3 of the rug, the taste is classified as “pretty”, and the room is classified as the “living R”.

In a case where the room classification results are compared with each other, only the partial image #2 of the bed is classified as the “bed R” while the other images are classified as the “living R”. Only the room classification of the partial image #2 of the bed is greatly different from the room classifications of the other images and is “left out”.

The room classification of the partial image #2 of the bed is not similar to the room classification of the whole image #0. In addition, the room classification of the partial image #2 of the bed is not similar to the room classifications of other partial images #1 and #3.

In this case, the weight w₂ of the taste (clear) is set to a low value for the partial image #2 of the bed having a low similarity of room classification. The weight w₁ and the weight w₃ of the taste are set to high values for the partial image #1 of the sofa and the partial image #3 of the rug having a high similarity of room classification (refer to FIG. 5).

The taste classification results s₀ to s_{N} are respectively weighted with the corresponding weights w₀ to w_{N} and are added together, and a weight sum s of the taste classification results s₀ to s_{N} is obtained. In the same manner as the taste classification result, the weight sum s is information representing the classification score that is the probability of membership to each of the plurality of categories as classifications. The category having a higher probability of membership than other categories is estimated to be the taste of the whole image #0.

By weighting and integrating the taste classification results s₀ to s_{N}, the taste originating from each of the plurality of objects is considered and reflected on the taste of the whole image #0.

Learned Classification Model

Next, the learned classification model will be described.

Each of the first impression classification unit 26 and the second impression classification unit 28 is a learned classification model that is learned using training data. In the present exemplary embodiment, a neural network such as a convolutional neural network (CNN) that is caused to learn by deep learning is used. The CNN is one example of a multilayer neural network having an input layer, a plurality of interlayers, and an output layer. Hereinafter, one example of a learning method will be described.

In deep learning, by providing a large amount of labeled image information as the training data, the CNN finds a pattern between data and automatically extracts and learns the optimal feature from the image.

First, the training data will be described.

FIG. 7 is a schematic diagram illustrating one example of training data according to the exemplary embodiment of the present invention. The image information representing a learning image is labeled with the first impression information representing the “first impression” received by the person from the image and the second impression information representing the “second impression” received by the person from the image. In the illustrated example, the same image information is labeled with taste information “natural” and room information “living R”.

The impression is subjective and changes depending on the viewer. Thus, in the present exemplary embodiment, a plurality of sets of the learning image information, the first impression information, and the second impression information acquired using a statistical method such as conducting a survey asking a plurality of people for the first impression and the second impression of the learning image are set as the “training data”. The classification model is learned using the training data. As the number of participants in the survey is increased, the reliability of the impression classification result is increased.

For example, in a case where the number of categories of classification such as the room, the age, and the sex is decided, a survey asking for any of the plurality of categories as classifications to which the impression of the learning image corresponds is conducted.

In a case where the number of categories as classifications such as the taste is not decided, a survey asking for the impression of the learning image may be conducted, and the category extracted from the survey may be used as the plurality of categories as classifications. In addition, even in a case where the number of categories as classifications is not decided, a user may set the plurality of categories as classifications and conduct a survey asking for any of the plurality of categories as classifications to which the impression of the learning image corresponds.

The training data includes “first training data” including a plurality of sets of the image information and the first impression information and “second training data” including a plurality of sets of the image information and the second impression information.

Next, a configuration of a learning function of the information processing apparatus 12 will be described.

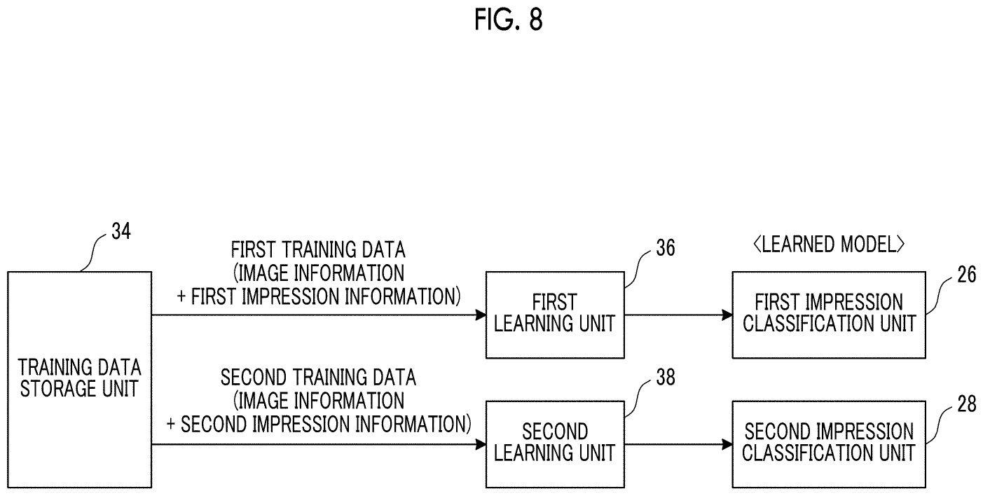

FIG. 8 is a block diagram illustrating one example of the configuration of the learning function of the information processing apparatus according to the exemplary embodiment of the present invention. As illustrated in FIG. 8, the information processing apparatus 12 includes a training data storage unit 34, a first learning unit 36, and a second learning unit 38. The training data storage unit 34 may be arranged outside the information processing apparatus 12.

The training data storage unit 34 stores the training data. For example, the first learning unit 36 constructs the first impression classification unit 26 by learning the classification model using deep learning with the image information as an input and the labeled first impression information as an output using the first training data stored in the training data storage unit 34.

Similarly, the second learning unit 38 constructs the second impression classification unit 28 by learning the classification model using deep learning with the image information as an input and the labeled second impression information as an output using the second training data stored in the training data storage unit 34.

Modification Example of Learning Method

In the above description, an example in which the first learning unit 36 constructs the first impression classification unit 26 by learning the classification model using the first training data, and the second learning unit 38 constructs the second impression classification unit 28 by learning the classification model using the second training data is described. However, the learning method is not for limitation purposes.

One example of a learning method for increasing the correlation between tasks for two tasks of the first impression classification unit 26 and the second impression classification unit 28 will be described.

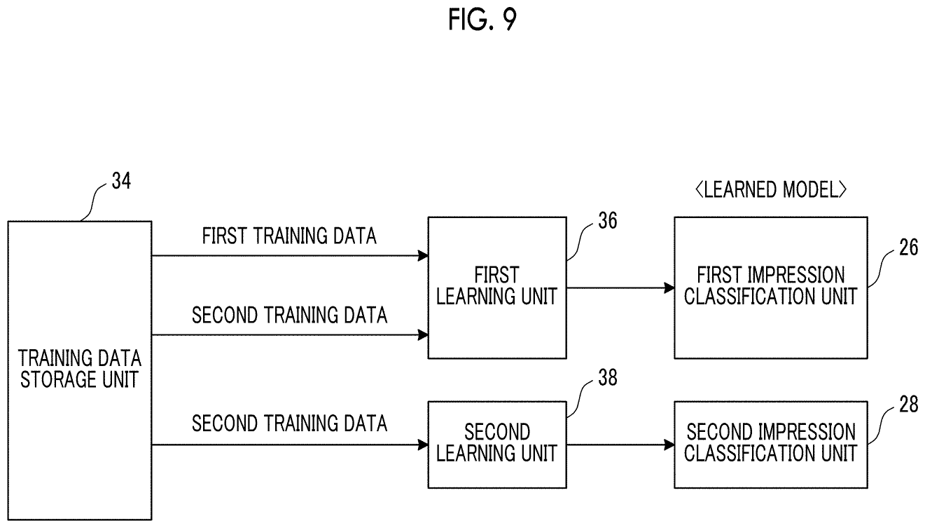

FIG. 9 is a block diagram illustrating another example of the configuration of the learning function of the information processing apparatus. For example, as illustrated in FIG. 9, the first learning unit 36 constructs the first impression classification unit 26 by learning the classification model using deep learning with the image information as an input and the labeled first impression information as an output using the first training data and the second training data.

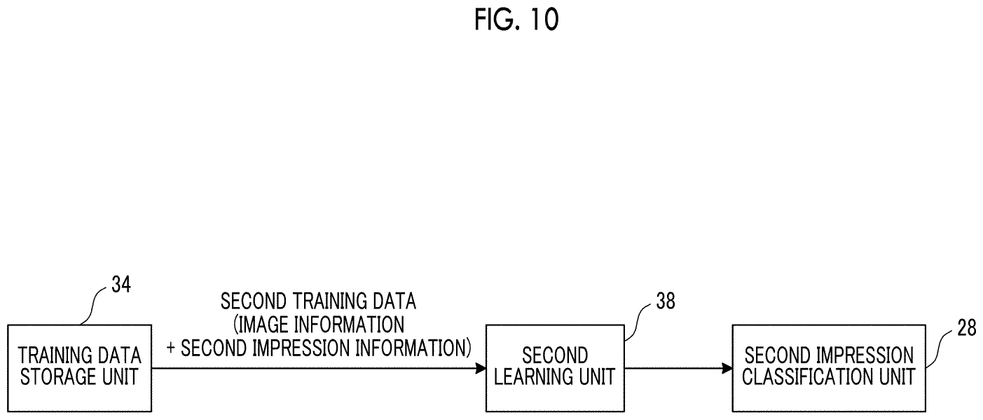

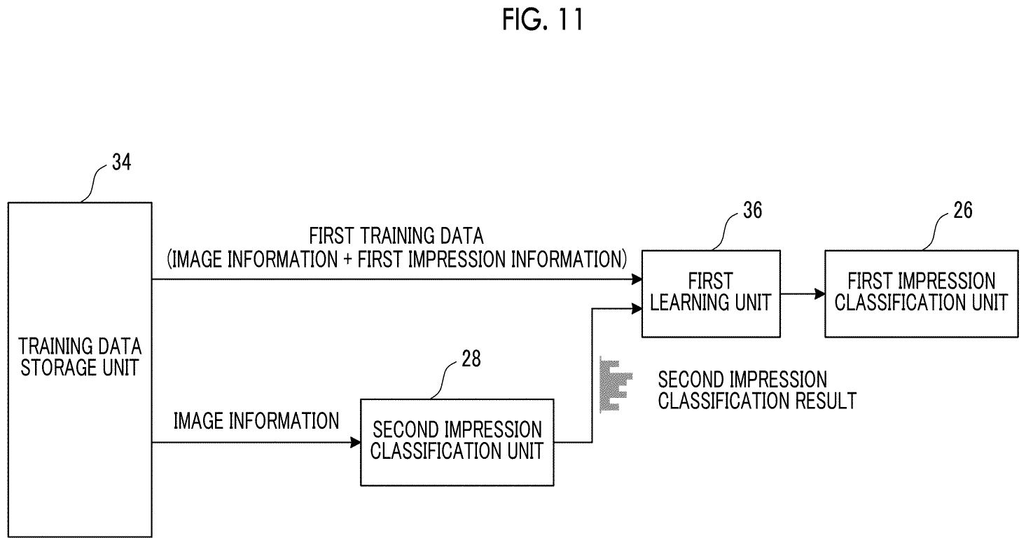

In addition, FIG. 10 and FIG. 11 are block diagrams illustrating still another example of the configuration of the learning function of the information processing apparatus. In this example, as illustrated in FIG. 10, the second impression classification unit 28 is first constructed. Next, as illustrated in FIG. 11, the second impression classification unit 28 outputs the second impression classification result in a case where the image information is input.

The first learning unit 36 may construct the first impression classification unit 26 by learning the classification model using deep learning with the image information and the second impression classification result acquired from the image information as an input and the labeled first impression information as an output using the first training data and the second impression classification result.

In the example of the taste (first impression) and the room (second impression) of the interior image, the taste is classified as illustrated in the following examples depending on the classification of the object (for example, the bed and the curtain) and the room classification result as a result of causing the CNN to learn using deep learning.

### Example 1

In a case where a black bed is in the bed R, the taste is classified as “simple”. In a case where the black bed is in the living R, the taste is classified as “unusual”. In this example, the taste classification result is corrected depending on the room classification result.

### Example 2

In addition, in a case where a patterned curtain is in the living R, the taste of the curtain is “prioritized”. That is, the weight of the taste of the curtain is increased. In this example, the weight of the taste is corrected depending on the room classification result.

Impression Classification Process

Next, an impression classification process will be described.

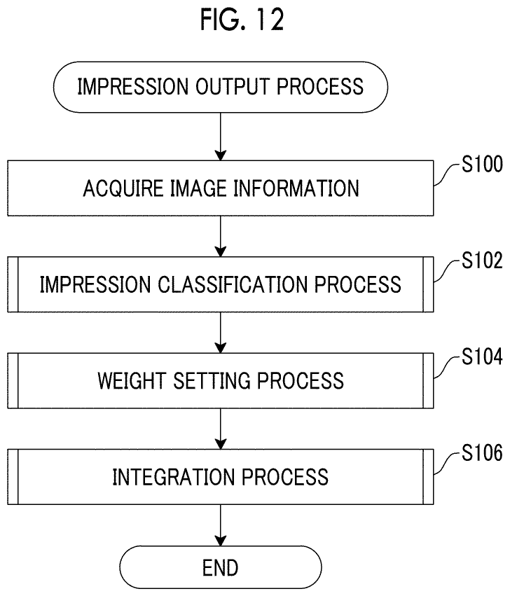

FIG. 12 is a flowchart illustrating one example of a flow of “impression output process” according to the exemplary embodiment of the present invention. A program for executing the “impression output process” is read from the ROM 12B and executed by the CPU 12A in a case where the user provides an instruction to execute the program.

First, in step S100 in FIG. 12, the image information related to the image (whole image) acquired by imaging the subject is acquired.

Next, in step S102 in FIG. 12, the “impression classification process” is executed.

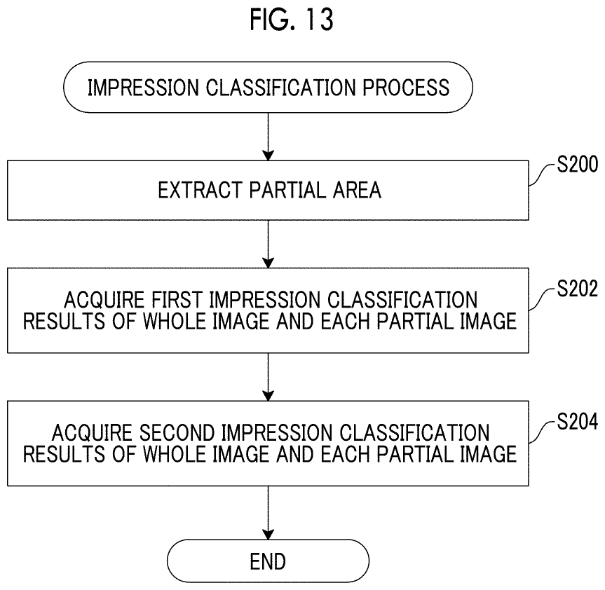

The “impression classification process” will be described in detail. FIG. 13 is a flowchart illustrating one example of a flow of “impression classification process”.

In step S200, the partial area including a part of the subject is extracted from the whole image. Accordingly, the image information related to the image (partial image) of the extracted partial area is acquired. Next, in step S202, the first impression classification results of the whole image and each partial image are acquired using the learned classification model. Next, in step S204, the second impression classification results of the whole image and each partial image are acquired using the learned classification model, and the routine of the impression classification process is finished.

Next, in step S104 in FIG. 12, a “weight setting process” is executed.

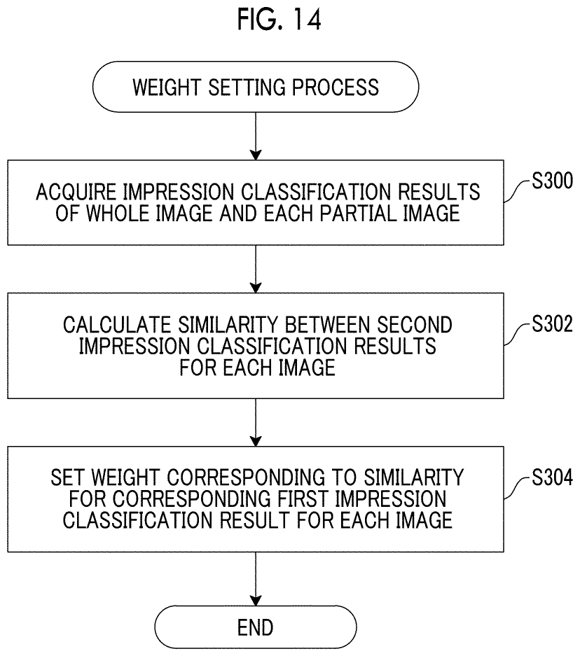

The “weight setting process” will be described in detail. FIG. 14 is a flowchart illustrating one example of a flow of “weight setting process”.

In step S300, the first impression classification results and the second impression classification results of the whole image and each partial image are acquired. Next, in step S302, the similarity between the corresponding second impression classification result and the second impression classification results of other partial images is calculated for each of the plurality of partial images. Next, in step S304, the weight corresponding to the similarity acquired in step S302 is set for the corresponding first impression classification result for the whole image and each partial image, and the routine of the weight setting process is finished.

Next, in step S106 in FIG. 12, the “integration process” of integrating the plurality of first impression classification results is executed using the weight acquired in step S104, and the routine of the “impression output process” is finished.

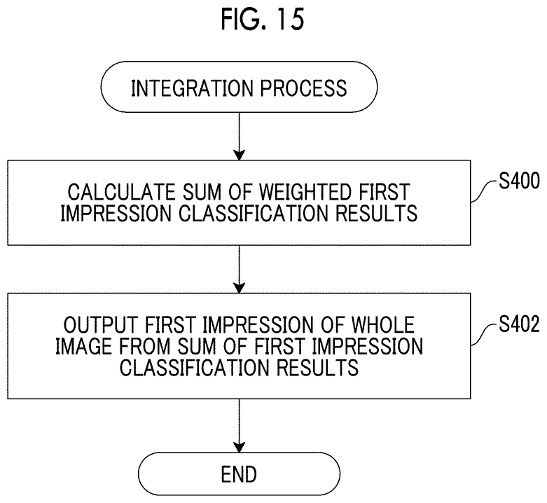

The “integration process” will be described in detail. FIG. 15 is a flowchart illustrating one example of a flow of “integration process”. In step S400, the “sum” of the plurality of weighted first impression classification results is calculated. Next, in step S402, the “first impression after correction” of the whole image estimated from the “weight sum” acquired in step S400 is output, and the routine of the integration process is finished.

### Modification Example

The configurations of the information processing apparatus and the program described in the exemplary embodiment are one example. The configurations may be changed without departing from the gist of the present invention.

### Other Specific Examples

While the specific example of estimating the “taste” of the interior image is described in the exemplary embodiment, the combination of the subject, the first impression, and the second impression is not for limitation purposes. The type of impression (what is perceived) changes depending on the subject. For example, the “age” may be estimated from a face image in which the subject is the face. In this example, the age acquired from the face image is set as the “first impression”, and the sex acquired from the face image is set as the “second impression”.

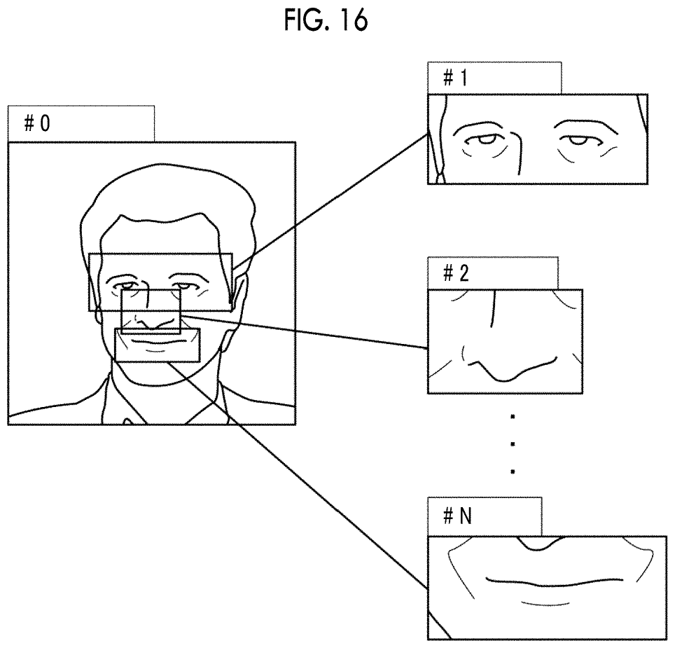

FIG. 16 is a schematic diagram describing a procedure of extracting the partial area from the face image. The face image is configured with a plurality of components such as eyes, a nose, and a mouth. The partial image is acquired for each component by detecting each of the plurality of components. In the illustrated example, three partial images of the partial image #1 of the eyes, the partial image #2 of the nose, and the partial image #3 of the mouth are acquired from the whole image #0.

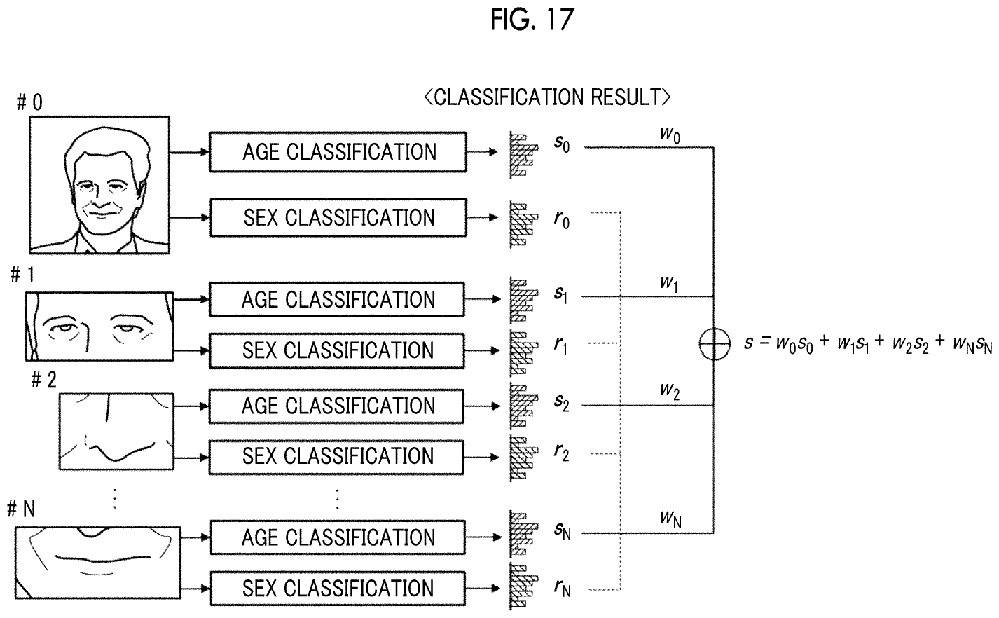

FIG. 17 is a schematic diagram specifically describing the procedure of integration process. As illustrated in FIG. 17, age classification and sex classification are performed for the whole image #0 and each of the partial images #1 to # N using the learned classification model. Age classification results s₀ to s_{N} and sex classification results r₀ to r_{N} are acquired from the whole image #0 and the partial images #1 to # N.

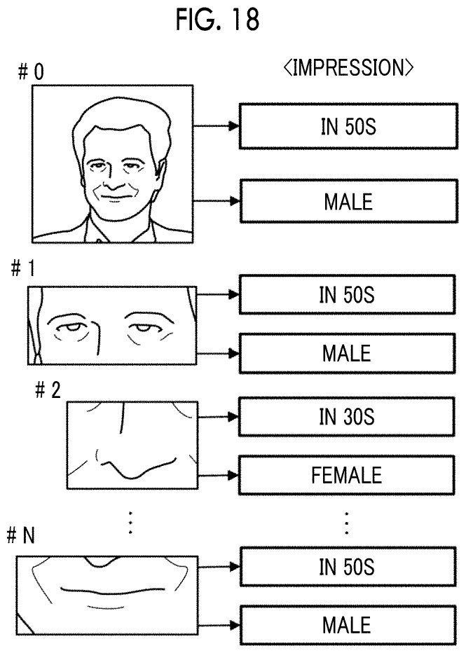

FIG. 18 is a schematic diagram illustrating one example of the age and the sex of the whole image and each partial image. As illustrated in FIG. 18, for the whole image #0, the partial image #1 of the eyes, and the partial image #3 of the mouth, the age is classified as “in 50s”, and the sex is classified as “male”. Meanwhile, for the partial image #2 of the nose, the age is classified as “in 30s”, and the sex is classified as “female”.

In a case where the sex classification results are compared with each other, only the partial image #2 of the nose is classified as “female” while the other images are classified as “male”. Only the sex classification of the partial image #2 of the nose is greatly different from the sex classifications of the other images and is “left out”.

The age classification and the sex classification are multi-tasks of performing classification by extracting a common feature from the same image. The sex classification result affects the age classification result. For example, in a case where the sex classification of the nose is estimated to be “female”, the age is estimated as “female”.

In this case, the weight w₂ of the age (in 30s) is set to a low value for the partial image #2 of the nose having a low similarity of sex classification. The weight w₁ and the weight w₃ of the age (in 50s) are set to high values for the partial image #1 of the eyes and the partial image #3 of the mouth having a high similarity of sex classification (refer to FIG. 17).

The age classification results s₀ to s_{N} are respectively weighted with the corresponding weights w₀ to w_{N} and are added together, and the weight sums of the age classification results s₀ to s_{N} is obtained. The “age” perceived by the person from the whole image #0 is estimated from the acquired weight sum s.

By weighting and integrating the age classification results s₀ to s_{N}, the age originating from each of the plurality of components is considered and reflected on the age classification of the whole image #0.

Usage Form of Learned Classification Model

While an example of acquiring the first impression classification result and the second impression classification result for the whole image and each partial image using the “learned classification model” is described in the exemplary embodiment, the usage form of the “learned classification model” is not for limitation purposes.

For example, a process up to extraction of the feature of the image may be externally performed. In this case, the first impression classification result and the second impression classification result are acquired from the extracted feature of the image using the “learned classification model”.

In addition, the partial area may be extracted using the “learned classification model”. In this case, in a case where the image information is input, the partial area is automatically extracted from the image information, and the first impression classification result and the second impression classification result for the whole image and each partial image are acquired.

Furthermore, the impression classification may be performed without using the “learned classification model”. The feature is extracted from the input image and is compared with features of a plurality of reference images prepared for each category as a classification of the impression. The category of the matching reference image is set as the impression of the input image.

For example, in the case of the taste classification of the interior image, the taste is classified into a plurality of categories by a color feature such as hue or tone, and the reference image is prepared for each category as a classification. The color feature of the input image is obtained, and the category of the reference image having the matching feature is set as the taste of the input image.

Impression Information

While an example of acquiring the impression classification result or the category of the impression as the “impression information” is described in the exemplary embodiment, various intermediate features are acquired before the classification result is acquired. The intermediate features may be set as the “impression information”.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an acquisition unit that acquires first impression information representing a first impression and second impression information representing a second impression for each of a plurality of images including an image in which a subject is imaged and a plurality of partial images including apart of the subject, the first impression being an impression received by a person, and the second impression being an impression received by the person and different from the first impression;
a setting unit that sets a weight corresponding to the corresponding second impression information for the first impression information related to each of the plurality of images based on each of the plurality of images and the second impression information; and
an output unit that outputs the first impression of the image in which the subject is imaged from the first impression information related to each of the plurality of images using the weight set by the setting unit.

2. The information processing apparatus according to claim 1,
wherein the partial image is an image of each object included in the subject or an image of each component constituting the subject.

3. The information processing apparatus according to claim 1,
wherein the setting unit sets the weight as the corresponding first impression information based on a similarity between the second impression information related to the corresponding partial image and the second impression information related to other images, the weight being increased as the similarity is increased.

4. The information processing apparatus according to claim 2,
wherein the setting unit sets the weight as the corresponding first impression information based on a similarity between the second impression information related to the corresponding partial image and the second impression information related to other images, the weight being increased as the similarity is increased.

5. The information processing apparatus according to claim 3,
wherein the similarity is
a similarity between the second impression information related to the corresponding partial image and the second impression information related to a whole image, or
a similarity between the second impression information related to the corresponding partial image and the second impression information related to the other partial images.

6. The information processing apparatus according to claim 4,
wherein the similarity is
a similarity between the second impression information related to the corresponding partial image and the second impression information related to a whole image, or
a similarity between the second impression information related to the corresponding partial image and the second impression information related to the other partial images.

7. The information processing apparatus according to claim 1,
wherein the second impression information is one category of the second impression.

8. The information processing apparatus according to claim 5,
wherein the second impression information is one category of the second impression.

9. The information processing apparatus according to claim 6,
wherein the second impression information is one category of the second impression.

10. The information processing apparatus according to claim 1,
wherein the acquisition unit acquires the first impression information and the second impression information using a convolutional neural network that is caused to learn in advance by deep learning using training data including a plurality of sets of learning image information, the first impression information, and the second impression information.

11. The information processing apparatus according to claim 2,
wherein the acquisition unit acquires the first impression information and the second impression information using a convolutional neural network that is caused to learn in advance by deep learning using training data including a plurality of sets of learning image information, the first impression information, and the second impression information.

12. The information processing apparatus according to claim 3,
wherein the acquisition unit acquires the first impression information and the second impression information using a convolutional neural network that is caused to learn in advance by deep learning using training data including a plurality of sets of learning image information, the first impression information, and the second impression information.

13. The information processing apparatus according to claim 4,
wherein the acquisition unit acquires the first impression information and the second impression information using a convolutional neural network that is caused to learn in advance by deep learning using training data including a plurality of sets of learning image information, the first impression information, and the second impression information.

14. The information processing apparatus according to claim 5,
wherein the acquisition unit acquires the first impression information and the second impression information using a convolutional neural network that is caused to learn in advance by deep learning using training data including a plurality of sets of learning image information, the first impression information, and the second impression information.

15. The information processing apparatus according to claim 6,
wherein the acquisition unit acquires the first impression information and the second impression information using a convolutional neural network that is caused to learn in advance by deep learning using training data including a plurality of sets of learning image information, the first impression information, and the second impression information.

16. The information processing apparatus according to claim 7,
wherein the acquisition unit acquires the first impression information and the second impression information using a convolutional neural network that is caused to learn in advance by deep learning using training data including a plurality of sets of learning image information, the first impression information, and the second impression information.

17. The information processing apparatus according to claim 8,
wherein the acquisition unit acquires the first impression information and the second impression information using a convolutional neural network that is caused to learn in advance by deep learning using training data including a plurality of sets of learning image information, the first impression information, and the second impression information.

18. The information processing apparatus according to claim 10,
wherein the first impression information is a first impression classification result representing a probability of membership to each of a plurality of different categories of the first impression set in advance, and
the second impression information is a second impression classification result representing a probability of membership to each of a plurality of different categories of the second impression set in advance.

19. The information processing apparatus according to claim 18,
wherein the output unit obtains a weight sum of the first impression classification results of the plurality of images using the weight set by the setting unit and outputs one category of the first impression estimated from the weight sum as the first impression of the image in which the subject is imaged.

20. A non-transitory computer readable medium storing a program causing a computer to function as each unit of the information processing apparatus according to claim 1.
